(19) United States
(12) Patent Application Publication
(10) Pub. No.: US 2022/0371308 A1
(43) Pub. Date: Nov. 24, 2022

(54) SHRINK FILMS INCORPORATING POST-CONSUMER RESIN AND METHODS THEREOF

(71) Applicant: Braskem S.A., Camaçari (BR)

(72) Inventors: Gabriel Degues Müller, São Paulo (BR); Leandro de Castro Tomasi, São Paulo (BR); Carlos André Silva, São Paulo (BR)

(73) Assignee: Braskem S.A., Camaçari (BR)

(21) Appl. No.: 17/769,694

(22) PCT Filed: Oct. 15, 2020
(86) PCT No.: PCT/IB2020/020062

§ 371 Date: Apr. 15, 2022

Related U.S. Application Data
(60) Provisional application No. 62/915,376, filed on Oct. 15, 2019.

(51) Int. Cl. B32B 27/08; B32B 27/32; B32B 7/022; B32B 7/08

(52) U.S. Cl. CPC B32B 27/08; B32B 27/32; B32B 7/022; B32B 7/08; B32B 2270/00; B32B 2250/03; B32B 2250/44; B32B 2250/242; B32B 2307/5825; B32B 2307/30; B32B 2307/72; B32B 2307/406; B32B 2307/736; B32B 2307/54; B32B 2272/00

(57) ABSTRACT

A shrink film may include at least one layer comprising a blended ethylene-based polymer composition, the blended ethylene-based having a PCR content varying from greater than 5 to less than 95 wt % and a virgin resin content varying from greater than 5 to less than 95 wt %, wherein the virgin resin is selected from HOPE, LLDPE, LDPE, or combinations thereof.

### BACKGROUND

Polyolefins such as polyethylene (PE) and polypropylene (PP) may be used to manufacture a varied range of articles, including films, molded products, foams, and the like. Polyolefins may have characteristics such as high processability, low production cost, flexibility, low density and recycling possibility. While plastics such as polyethylene have many beneficial uses, production and manufacture of plastics and plastic articles often impacts the environment in detrimental ways including trash production and increased emission of CO2 during processing.

One of the largest challenges faced by society today is to reduce greenhouse gas emissions in order to minimize the impact on the climate and environment. International agreements such as the Paris Agreement of 2015 may set limits on CO₂ emissions and drive the transition to a low carbon economy based on renewable energy, in addition to the development of new economic and business models. In some cases, new production techniques and material solutions may be used to reduce the carbon footprint during plastic manufacture, and a life cycle perspective may be applied to weight the possible trade-offs between material functionality and environmental impact

Another great challenge of the society is to rethink the use of plastics in order to reduce the environmental impact of the waste residues. One of the options is to mechanically recycle the consumed plastic to reintroduce it in the plastic value chain. Post-consumer resins (PCR) are available in the market, but because of the high inhomogeneity of sources and the chemical and mechanical damages that the plastic suffers in its entire chain (from the production to the waste), the properties of those resins are generally poor, being a challenge to reuse them in many applications that require high property standards.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a shrink film that includes at least one layer comprising a blended ethylene-based polymer composition, the blended ethylene-based having a PCR content varying from greater than 5 to less than 95 wt % and a virgin resin content varying from greater than 5 to less than 95 wt %, wherein the virgin resin is selected from HDPE, LLDPE, LDPE, or combinations thereof.

In another aspect, embodiments disclosed herein relate to a method for preparing a shrink film that includes at least one layer comprising a blended ethylene-based polymer composition, the blended ethylene-based having a PCR content varying from greater than 5 to less than 95 wt % and a virgin resin content varying from greater than 5 to less than 95 wt %, wherein the virgin resin is selected from HDPE, LLDPE, LDPE, or combinations thereof, wherein the method includes: dry blending the PCR and the virgin resin selected from HDPE, LDPE, LLDPE, or combinations thereof to form the blended ethylene-based polymer composition; and extruding the shrink film.

In another aspect, embodiments disclosed herein relate to a method for preparing a shrink film that includes at least one layer comprising a blended ethylene-based polymer composition, the blended ethylene-based having a PCR content varying from greater than 5 to less than 95 wt % and a virgin resin content varying from greater than 5 to less than 95 wt %, wherein the virgin resin is selected from HDPE, LLDPE, LDPE, or combinations thereof, wherein the method includes: melt blending the PCR and the virgin resin selected from HDPE, LDPE, LLDPE, or combinations thereof to form the blended ethylene-based polymer composition; and extruding the shrink film of any of the above claims.

1. In yet another aspect, embodiments disclosed herein relate to use of an ethylene-based polymer composition comprising a blend of PCR with a virgin resin selected from HDPE, LDPE, and/or LLDPE to form a shrink film that includes at least one layer comprising a blended ethylene-based polymer composition, the blended ethylene-based having a PCR content varying from greater than 5 to less than 95 wt % and a virgin resin content varying from greater than 5 to less than 95 wt %, wherein the virgin resin is selected from HDPE, LLDPE, LDPE, or combinations thereof.

Other aspects and advantages of the claimed subject matter will be apparent from the following description and the appended claims.

### DETAILED DESCRIPTION

In one aspect, embodiments disclosed herein relate to shrink films that contain blended polymer compositions (based on polyethylene in particular) that exhibit a reduction in carbon emissions and overall potential environmental impact when compared to equivalent materials produced using exclusively virgin and/or exclusively fossil fuel sources. In particular, the production of such shrink films may have a mono- or multi-layer structure that incorporates, in at least one of the layers, an ethylene-based polymer composition that is combination or blend of post-consumer resin (PCR) with a virgin resin of high density polyethylene (HDPE) and/or low density polyethylene (LDPE) and/or linear low density polyethylene (LLDPE). In one or more particular embodiments, the HPDE, LDPE, and/or LLDPE in the ethylene-based polymer compositions (including the blended compositions) is a virgin biobased resin, but other embodiments are directed to a virgin petrochemical resin. Further, as the present embodiments are directed to shrink films, at least one of the layers of the film contains LDPE therein.

The shrink films may be, in one or more embodiments, a trilayer structure, in which a core (or second) layer is between a first layer and a third layer. Further, it is also envisioned that the articles may include more than three layers.

Generally, at least one, but up to each of the three (or more) layers may be formed from ethylene-based resin(s) (i.e., is an ethylene-based polymer composition), having a PCR content ranging from 5 to 95 wt % of the respective layer and a virgin resin content ranging from 5 to 95 wt % of the respective layer, where the virgin resin is selected from the group consisting of HDPE, LDPE, LLDPE, and combinations thereof. In accordance with one or more embodiments of the present disclosure, at least one of the at least three layers is formed from an ethylene-based polymer composition that includes a blend of PCR and virgin resin (HDPE, LDPE, and/or LLDPE). Given that each layer is an ethylene-based composition, the layer that contains both PCR and virgin resin is referred to as a “blended ethylene-based polymer composition.”

Virgin Resin

Virgin resin may be present in any layer of the shrink film, but in accordance with one or more embodiments, it is at least present in the blended ethylene-based polymer composition. The virgin resin (in any layer, including, but not limited to the blended ethylene-based polymer composition) may be selected from HDPE, LDPE, and/or LLDPE.

The HDPE and/or LDPE and/or LLDPE can be a homopolymer of ethylene or contain small amounts of comonomer selected from an alpha olefin containing 3 to 10 carbon atoms, preferably 4 to 10 carbon atoms. In these instances, the LDPE, LLDPE, and HDPE polymers may contain greater than 93% of its weight as ethylene units.

While one or more embodiments may use a petrochemical HDPE, LDPE, and/or LLDPE virgin resin in the ethylene-based polymer compositions (in any layer of the shrink film), in one or more particular embodiments, the virgin resin may be bio-based. In particular embodiments using a blend of biobased resin and PCR, the ethylene-based polymer composition may have a particularly low carbon emission (or even a carbon uptake) through the selection of the amounts of the two components in the blended composition.

Biobased ethylene polymers (HDPE, LDPE, and/or LLDPE) in accordance with the present disclosure may include polyolefins containing a weight percentage of biologically derived monomers. Biobased ethylene polymers and monomers that are derived from natural products may be distinguished from polymers and monomers obtained from fossil-fuel sources (also referred to as petroleum-based polymers). Because biobased materials are obtained from sources that actively reduce CO₂ in the atmosphere or otherwise require less CO₂ emission during production, such materials are often regarded as “green” or renewable. The use of products derived from natural sources, as opposed to those obtained from fossil sources, has increasingly been widely preferred as an effective means of reducing the increase in atmospheric carbon dioxide concentration, therefore effectively limiting the expansion of the greenhouse effect. Products thus obtained from natural raw materials have a difference, relative to fossil sourced products, in their renewable carbon contents. This renewable carbon content can be certified by the methodology described in the technical ASTM D 6866-18 Norm, “Standard Test Methods for Determining the Biobased Content of Solid, Liquid, and Gaseous Samples Using Radiocarbon Analysis”. Products obtained from renewable natural raw materials have the additional property of being able to be incinerated at the end of their life cycle and only producing CO₂ of a non-fossil origin.

Examples of biobased ethylene-based polymers may include polymers generated from ethylene derived from natural sources such as sugarcane and sugar beet, maple, date palm, sugar palm, sorghum, American agave, starches, corn, wheat, barley, sorghum, rice, potato, cassava, sweet potato, algae, fruit, citrus fruit, materials comprising cellulose, wine, materials comprising hemicelluloses, materials comprising lignin, cellulosics, lignocelluosics, wood, woody plants, straw, sugarcane bagasse, sugarcane leaves, corn stover, wood residues, paper, polysaccharides such as pectin, chitin, levan, pullulan, and the like, and any combination thereof.

Biobased materials may be processed by any suitable method to produce ethylene, such as the production of ethanol from sugarcane, and the subsequent dehydration of ethanol to ethylene. Further, it is also understood that the fermenting produces, in addition to the ethanol, byproducts of higher alcohols. If the higher alcohol byproducts are present during the dehydration, then higher alkene impurities may be formed alongside the ethanol. Thus, in one or more embodiments, the ethanol may be purified prior to dehydration to remove the higher alcohol byproducts while in other embodiments, the ethylene may be purified to remove the higher alkene impurities after dehydration.

Biologically sourced ethanol, known as bio-ethanol, used to produce ethylene may be obtained by the fermentation of sugars derived from cultures such as that of sugar cane and beets, or from hydrolyzed starch, which is, in turn, associated with other materials such as corn. It is also envisioned that the biobased ethylene may be obtained from hydrolysis based products from cellulose and hemi- cellulose, which can be found in many agricultural by-products, such as straw and sugar cane husks. This fermentation is carried out in the presence of varied microorganisms, the most important of such being the yeast Saccharomyces cerevisiae. The ethanol resulting therefrom may be converted into ethylene by means of a catalytic reaction at temperatures usually above 300° C. A large variety of catalysts can be used for this purpose, such as high specific surface area gamma-alumina. Other examples include the teachings described in U.S. Pat. Nos. 9,181,143 and 4,396,789, which are herein incorporated by reference in their entirety.

In one or more embodiments, biobased products obtained from natural materials may be certified as to their renewable carbon content, according to the methodology described in the technical standard ASTM D 6866-18, “Standard Test Methods for Determining the Biobased Content of Solid, Liquid, and Gaseous Samples Using Radiocarbon Analysis.”

Biobased resins (including biobased HDPE, biobased LDPE, and biobased LLDPE) in accordance with the present disclosure may include an ethylene-containing resin having biobased carbon content as determined by ASTM D6866-18 Method B of at least 5%, or having a lower limit of any of 5%, 10%, 15%, 25%, 40% and 50% and an upper limit selected from any of 60%, 75%, 90%, 98%, and 100%, where any lower limit may be combined with any upper limit.

In one or more embodiments, one or more of the ethylene-based polymer compositions includes an HDPE and/or LDPE and/or LLDPE (each of which may optionally be biobased) that has a melt index measured according to ASTM D1238 at 190° C./2.16 kg ranging from 0.1 to 2 g/10 min. In particular, the melt index may have a lower limit ranging from any of 0.1, 0.2, or 0.3 g/10 min to an upper limit ranging from any of 0.4, 0.5, 1 or 2 g/10 min, where any lower limit can be used in combination with any upper limit.

In one or more embodiments, one or more of the ethylene-based polymer compositions includes an HDPE (which may optionally be biobased) that has a density measured according to ASTM D 792 ranging from 0.940 to 0.960 g/cm³. In particular, the density may range from a lower limit of any of 0.940, 0.945, and 0.950 g/cm³ to an upper limit of any of 0.950, 0.955, 0.960, 0.965, and 0.970 g/cm³, where any lower limit can be used in combination with any upper limit.

In one or more embodiments, one or more of the ethylene-based polymer compositions includes an LDPE and/or LLDPE (which may optionally be biobased) that has a density measured according to ASTM D 792 ranging from 0.910 to 0.930 g/cm³. In particular, the density may range from a lower limit of any of 0.910, 0.915, and 0.920 g/cm³, to an upper limit of any of 0.920, 0.925, 0.930, 0.935, and 0.940 g/cm³, where any lower limit can be used in combination with any upper limit.

In one or more embodiments, one or more of the ethylene-based polymer compositions includes an HDPE (which may optionally be biobased) that has a tensile strength at yield, measured according to ASTM D 638 (using a 2 mm thickness compression molded plaques prepared according to ASTM D4703) that is greater than 20 MPa. In particular, the tensile strength at yield may be greater than 20 MPa, 25 MPa or even 30 MPa.

In one or more embodiments, one or more of the ethylene-based polymer compositions includes an HDPE (which may optionally be biobased) that has a tensile strength at break, measured according to ASTM D 638 (using a 2 mm thickness compression molded plaques prepared according to ASTM D4703) that is greater than 20 MPa. In particular, the tensile strength at break may be greater than 20 MPa, 25 MPa or even 30 MPa.

In one or more embodiments, one or more of the ethylene-based polymer compositions includes an HDPE (which may optionally be biobased) that has a flexural modulus at 1% secant, measured according to ASTM D 790 (using a 3 mm thickness compression molded plaques prepared according to ASTM D4703) that is greater than 900 MPa. In particular, the flexural modulus may have a lower limit ranging from any of 900, 1000, or 1300 to an upper limit of any of 1400, 1500, 1600, or 1800 MPa, where any lower limit can be used in combination with any upper limit.

In one or more embodiments, one or more of the ethylene-based polymer compositions includes an HDPE (which may optionally be biobased) that has an environmental stress cracking resistance, measured according to ASTM D 1693 Condition B, that is greater than 5 or 10 hours to 50% failure. In particular, the environmental stress cracking resistance may be greater than 5 hours, 10 hours, 20 hours, 30 hours, 50 hours or 100 hours to 50% failure.

In one or more embodiments, one or more of the ethylene-based polymer compositions includes an HDPE (which may optionally be biobased) that has an environmental stress cracking resistance, measured according to ASTM D 1693 Condition C, that is greater than 8 hours to 50% failure. In particular, the environmental stress cracking resistance may be greater than 40 hours, 50 hours, 60 hours, 70 hours, 100 hours, or even 200 hours to 50% failure.

In one or more embodiments, one or more of the ethylene-based polymer compositions includes HDPE (which may optionally be biobased) in the blended ethylene-based polymer composition has a Shore D hardness, measured according to ASTM D 2240, higher than 50 Shore D. In particular, the hardness Shore D may be greater than 60 Shore D, 70 Shore D, or even 80 Shore D.

In one or more embodiments, one or more of the ethylene-based polymer compositions includes HDPE (which may optionally be biobased) in the blended ethylene-based polymer composition has a heat deflection temperature, measured according to ASTM D648 under load at 0.455 MPa (using a 3 mm thickness compression molded plaques prepared according to ASTM D4703), greater than 50° C. In particular embodiments, the heat deflection temperature may be greater than 50° C., 55° C., 60° C. or even 65° C.

In one or more embodiments, one or more of the ethylene-based polymer compositions includes HDPE (which may optionally be biobased) in the blended ethylene-based polymer composition has a Vicat softening temperature at 10N, measured according to ASTM D1525 (using a 3 mm thickness compression molded plaques prepared according to ASTM D4703), of greater than 90° C. In particular embodiments, the Vicat softening temperature be greater than 90° C., 95° C., 100° C., 115° C. or even 120° C.

In one or more embodiments, one or more of the ethylene-based polymer compositions includes a LDPE (which may optionally be biobased) that has a tensile strength at break, measured according to ASTM D 882 (using a film of 70 μm thickness, obtained in a 40 mm extruder, with a blow ratio of 2.2:1 and a die opening of 1.0 mm) in machine direction (MD) that is greater than 10 MPa and in transversal direction (TD) that is greater than 10 MPa. In particular, the tensile strength at break may have a lower limit ranging from any of 10, 12, or 15 MPa to an upper limit of any of 20, 25 or 30 MPa in machine direction (MD) and a lower limit ranging from any of 10, 12, or 15 MPa to an upper limit of any of 20, 25 or 30 MPa in transversal direction (TD), where any lower limit can be used in combination with any upper limit.

In one or more embodiments, one or more of the ethylene-based polymer compositions includes a LDPE (which may optionally be biobased) wherein the LDPE in the blended composition has an elongation at break, measured according to ASTM D 882 (using a film of 70 μm thickness, obtained in a 40 mm extruder, with a blow ratio of 2.2:1 and a die opening of 1.0 mm) in machine direction (MD) greater than 250% and in transversal direction (TD) greater than 700%. In particular, the elongation at break may be greater than 250%, 270%, 300% or even 380% in machine direction (MD) and greater than 700%, 750%, 800% or even 900% in transversal direction (TD).

In one or more embodiments, one or more of the ethylene-based polymer compositions includes a LDPE (which may optionally be biobased) wherein the LDPE in the blended composition has a tensile modulus at 2% secant, measured according to ASTM D 882 (using a film of 70 μm thickness, obtained in a 40 mm extruder, with a blow ratio of 2.2:1 and a die opening of 1.0 mm) in a machine direction (MD) greater than 90 MPa and in transversal direction (TD) greater than 100 MPa. In particular, the tensile modulus at 2% secant may be greater than 90, 100, 120 or even 130 MPa in machine direction (MD) and greater than 100, 110, 130 or even 150 MPa in transversal direction (TD).

In one or more embodiments, one or more of the ethylene-based polymer compositions includes a LDPE (which may optionally be biobased) wherein the LDPE in the blended composition has a Dart Drop impact, measured according to ASTM D1709 Method A (using a film of 70 μm thickness, obtained in a 40 mm extruder, with a blow ratio of 2.2:1 and a die opening of 1.0 mm), of greater than 100 g (F50). In particular, the dart drop impact may be greater than 100, 150, 200, or even 220 g (F50).

In one or more embodiments, one or more of the ethylene-based polymer compositions includes a LDPE (which may optionally be biobased) wherein the LDPE in the blended composition has an Elmendorf tear strength, measured according to ASTM D 1922(using a film of 70 μm thickness, obtained in a 40 mm extruder, with a blow ratio of 2.2:1 and a die opening of 1.0 mm), that is greater than 150 gF in machine direction (MD) and greater than 120 gF in transversal direction (TD). In particular, the Elmendorf tear strength may be greater than 150, 200, 250 or even 300 gF in machine direction and greater than 120, 150, 180 or even 220 gF in transversal direction.

In one or more embodiments, one or more of the ethylene-based polymer compositions includes a LDPE (which may optionally be biobased) wherein the LDPE in the blended composition has a haze, measured according to ASTM D 1003 (using a film of 70 μm thickness, obtained in a 40 mm extruder, with a blow ratio of 2.2:1 and a die opening of 1.0 mm), of less than 60%. In particular, the haze may be less than 60%, 50%, 30% or even 20%.

In one or more embodiments, one or more of the ethylene-based polymer compositions includes a LDPE (which may optionally be biobased) wherein the LDPE in the blended composition has a gloss at an angle of 45°, measured according to ASTM D2457 (using a film of 70 μm thickness, obtained in a 40 mm extruder, with a blow ratio of 2.2:1 and a die opening of 1.0 mm) of greater than 15. In particular, the gloss at an angle of 45° may be greater than 15, 20, 25, 30 or even 35.

Post-Consumer Resin

PCR may be present in any layer of the shrink films, but in accordance with one or more embodiments, it is at least present in the blended ethylene-based polymer composition. In particular embodiments, PCR is present in a core layer (i.e, in a layer that is between the inner and outer layers). In particular embodiments when the shrink film comprises three layers (i.e, a first, a second and a third layer), the PCR may be present at least in the second layer.

In one or more embodiments, the PCR present in the one or more ethylene-based polymer compositions may be an ethylene-based PCR. PCR (post-consumer resin) refers to resin that is recycled after consumer use thereof. Generally, PCR may include resins having been used in rigid applications (such as PCR from previously blow molded articles, normally from 3D-shaped articles) as well as in flexible applications (such as from films and industrial bags). In one or more particular embodiments, the PCR used in the one or more ethylene-based polymer compositions may include PCR originally used in flexible applications. In particular embodiments, PCR may have a high amount of LDPE (such as PCRs obtained from the recycling of industrial bags), though with the recycling process, it is understood that impurities may be present and that the material source may include a flexible LDPE or HDPE. Thus, it is understood that the PCR may be a mixture of polyethylenes, but is may be predominantly LLDPE. Further, it is also envisioned that the PCR may include recycled LLDPE, which may be derived from industrial bag(s).

In one or more embodiments, one or more of the ethylene-based polymer compositions includes a PCR that has a melt index measured according to ASTM D1238 at 190° C./2.16 kg ranging from 0.10 to 3 g/10 min. In particular, the melt index may have a lower limit ranging from any of 0.10, 0.20, 0.30, to 0.40 g/10 min to an upper limit of any of 0.40, 0.60, 0.90, 1, 2, 3 or 4 g/10 min, where any lower limit can be used in combination with any upper limit.

In one or more embodiments, one or more of the ethylene-based polymer compositions includes a PCR that has a density measured according to ASTM D 792 greater than 0.900 g/cm³ to 0.960 g/cm³. In particular, the density may have a lower limit ranging from any of 0.910, 0.920, or 0.930 g/cm³ to an upper limit of any of 0.940, 0.950 or 0.960 g/cm³, where any lower limit can be used in combination with any upper limit.

In one or more embodiments, one or more of the ethylene-based polymer compositions includes a PCR that has a tensile strength at yield, measured according to ASTM D 882 (using a film of 60 μm thickness, obtained in a 30 mm extruder, with a blow ratio of 2.2:1 and a die opening of 1.8 mm), that is greater than 3 MPa at machine direction (MD) and greater than 6 MPa at transversal direction (TD). In particular, the tensile strength at yield may be greater than 3, 4, 5 or even 9 MPa at MD and greater than 6, 7, 10 or even 11 MPa at TD.

In one or more embodiments, one or more of the ethylene-based polymer compositions includes a PCR that has a tensile strength at break, measured according to ASTM D 882 (using a film of 60 μm thickness, obtained in a 30 mm extruder, with a blow ratio of 2.2:1 and a die opening of 1.8 mm) that is greater than 10 MPa at machine direction (MD) and greater than 10 MPa at transversal direction (TD). In particular, the tensile strength at break may be greater than 10, 15, 20 or even 22 MPa at MD and greater than 10, 15, 20 or even 22 MPa at TD.

In one or more embodiments, one or more of the ethylene-based polymer compositions includes a PCR that has a tensile modulus at 1% secant, measured according to ASTM D 882 (using a film of 60 μm thickness, obtained in a 30 mm extruder, with a blow ratio of 2.2:1 and a die opening of 1.8 mm), of greater than 90 MPa at machine direction (MD) and greater than 100 at transversal direction (TD). In particular, the tensile modulus at 1% secant may be greater than 90, 100, 150, 180 or even 190 MPa at MD and greater than 100, 120, 150, 190 or even 220 MPa at TD.

In one or more embodiments, one or more of the ethylene-based polymer compositions includes a PCR that has a Dart drop impact, measured according to ASTM D1709 Method A (using a film of 60 μm thickness, obtained in a 30 mm extruder, with a blow ratio of 2.2:1 and a die opening of 1.8 mm), of greater than 100 g (F50). In particular, the dart drop impact may be greater than 100, 120, 130, 150, 160 or even 165 g (F50).

In one or more embodiments, one or more of the ethylene-based polymer compositions includes a PCR that has an Elmendorf tear strength, measured according to ASTM D 1922, that is greater than 75 gF at machine direction (MD) and greater than 300 gF at transversal direction (TD). In particular, the Elmendorf tear strength may be greater than 75, 80, 100 or even 120 gF at MD and greater than 300, 400, 500, 600 or even 640 gF at TD.

Blended Ethylene-Based Polymer Composition

As mentioned above, one or more of the ethylene-based polymer compositions includes a blend of virgin resin and PCR, and may be referred to as the blended ethylene-based polymer composition.

In one or more embodiments, blended polymer compositions, containing both virgin resin and PCR, may contain a percent by weight, based on the total composition (wt %) of the blend, of a virgin resin (HDPE and/or LDPE and/or LLDPE, any of which may optionally be biobased) ranging from a lower limit selected from one of 1 wt %, 5 wt %, 7.5 wt %, 10 wt %, 15 wt %, and 20 wt % to an upper limit selected from one of 30 wt %, 40 wt %, 50 wt % wt %, 85 wt %, 95 wt %, and 99 wt %, where any lower limit can be used with any upper limit. Further, it is envisioned that a polymer composition may contain more or less biobased ethylene-based polymers depending on the application and the desired carbon emission profile, discussed below.

In one or more embodiments, the blended ethylene-based polymer compositions may contain a percent by weight, based on the total composition (wt %) of the blend, a PCR content ranging from a lower limit selected from one of 5 wt %, 10 wt %, 15 wt %, 20 wt %, 30wt %, 40 wt %, 50 wt %, and 60 wt % to an upper limit selected from one of 60 wt %, 70 wt %, 80 wt % wt %, 90 wt %, 95 wt %, and 99 wt %, where any lower limit can be used with any upper limit. Further, it is envisioned that a polymer composition may contain more or less PCR depending on the application and the desired carbon emission profile.

In one or more embodiments, methods of blended polymer composition manufacture may exhibit carbon emission close to zero mass equivalents of CO₂ per mass of polymer (i.e., kg CO₂/kg polymer). In some embodiments, the mass equivalents of CO₂ per mass of a polymer composition may be negative, indicating a carbon uptake (also referred as carbon sequestration) of CO₂ from the atmosphere. Blended polymer compositions in accordance with the present disclosure may include a mixture of a biobased polymer composition (biobased HDPE, LDPE, and/or LLDPE) and a recycled polymer composition (such as PCR) and optionally a mixture of a petrochemical based polymer composition (petrochemical based HDPE, LDPE, and/or LLDPE), where the amount of each component is selected based on the calculated carbon footprint as determined by an “Emission Factor” calculated as shown in Eq. 1:

P1_{Biobased}·Emission factor_{P1Biobased}+P2_{Recycled}·Emission factor_{P2Recycled}+P3_{Petro}·Emission factor_{P3Petro}=Emission factor_{blend} (1)

wherein P1_{Biobased} is the weight percentage of the biobased HDPE, biobased LDPE, and/or biobased LLDPE, P2_{Recycled} is the weight percent of the PCR, and P3_{Petro} is the weight percent of the virgin petrochemical based HDPE, petrochemical based LDPE or petrochemical based LLDPE; Emission factor_{P1Biobased} is the calculated emission for the biobased HDPE, biobased LDPE, and/or biobased LLDPE in kg CO₂/kg PE, Emission factor_{P2Recycled} is the calculated emission for the PCR in kg CO₂/kg PE, Emission factor_{P3Petro} is the calculated emission for the virgin petrochemical based HDPE, petrochemical based LDPE or petrochemical based LLDPE, and Emission factor_{Blend} is the calculated emission for the blended ethylene-based polymer composition in kg CO₂/kg blended ethylene-based polymer composition. In one or more embodiments, blended polymer compositions in accordance with the present disclosure may have an Emission Factor as calculated according to Eq. 1 that is less than 1.0 kg CO₂/kg polymer composition. In some embodiments, polymer compositions may have an Emission Factor as calculated according to Eq. 1 in the range of range of −1.0 to 1.0 kg CO₂/kg blended polymer composition. While a range of Emission Factors are presented, it is envisioned that the Emission Factor may be approximately 0 or less negative than −1 in some embodiments, depending on the available starting materials and application requirements of the final polymer composition. For example, in one or more embodiments, the Emission Factor may have a lower limit of any of −1.0, −0.8, −0.6, −0.4, −0.2 or −0.1, and an upper limit of any of 0.1, 0.2, 0.4, 0.6, 0.8, or 1.0, where any lower limit can be used in combination with any upper limit.

As disclosed herein, the Emission Factor of polymer compositions may be calculated according to the international standard ISO 14044:2006—“ENVIRONMENTAL MANAGEMENT—LIFE CYCLE ASSESSMENT—REQUIREMENTS AND GUIDELINES”. The boundary conditions consider the cradle to gate approach. Numbers are based on peer reviewed LCA ISO 14044 compliant study and the environmental and life cycle model are based on SimaPro® software. Ecoinvent is used as background database and IPCC 2013 GWP100 is used as LCIA method.

In one or more embodiments, when a biobased HDPE and/or a biobased LDPE and/or a biobased LLDPE is present, the blended ethylene-based polymer compositions exhibit a biobased carbon content as determined by ASTM D6866-18 Method B of at least 5%.

Shrink Films and Methods Forming Shrink Films

Embodiments of the present disclosure includes shrink films comprising at least one layer comprising the blended ethylene-based polymer composition as described above. In one or more embodiments, shrink films may comprise a single layer (i.e., may be a mono-layer film). In other embodiments, shrink films may comprise two or more layers (i.e., may be multilayer films). In particular embodiments, shrink films may comprise three layers.

In one or more embodiments, the film has a PCR content ranging from 5 to 70 wt % based in the total weight of the film, a LDPE content of at least 25 wt % based in the total weight of the film; optionally a virgin LLDPE content of less than 50 wt % based in the total weight of the film and optionally a HDPE content of less than 40 wt % based in the total weight of the film.

The thickness of the film and each layer and the core layer may be selected as desired for a particular purpose or intended use. In one embodiment, the thickness of the film may be from about 10 to about 250 microns. Further, in embodiments having multiple layers, it is envisioned that the core layer may be at least 1.5 or 2 times the thickness of the inner and outer layers.

In one or more embodiments, the film may have a gloss at a 45° angle, measured according to ASTM D2457 ranging that is greater than 10.

In one or more embodiments, the film may have an Elmendorf tear strength, measured according to ASTM D 1922, that is greater than 20 gF in machine direction (MD) and greater than 600 gF in transversal direction (TD).

In one or more embodiments, the film may have a shrink strength, measured according to ASTM D2732, that is greater than 50% at machine direction and greater than 8% at transversal direction.

In one or more embodiments, the film may have a cold seal at medium strength, measured according to ASTM F2019, greater than 20 N.

In one or more embodiments, the film may have a cold seal at maximum strength, measured according to ASTM F2019, greater than 25 N.

In one or more embodiments, the film may have a cold seal sealing temperature, measured according to ASTM F2019, lower than 130° C. or less than 140° C.

In one or more embodiments, the film may have a tensile modulus at 1% secant, measured according to ASTM D 882, of greater than 150 MPa in machine direction (MD) and greater than 250 MPa in transversal direction (TD).

In one or more embodiments, the film may have a tensile strength at yield, measured according to ASTM D 882, of greater than 8 MPa in machine direction and greater than 10 MPa in transversal direction.

In one or more embodiments, the film may have a tensile strength at break, measured according to ASTM D 882, of greater than 15 MPa in machine direction (MD) and greater than 12 MPa in transversal direction (TD).

In one or more embodiments, the blended ethylene-based polymer composition forms a middle layer of the shrink film.

In addition to the above described components, it is also envisioned that the ethylene-based polymer composition (as well any layer of the shrink film) may also include least one additive selected from antioxidants, optical brightener, processing aids, coloring agents, internal plasticizers, external plasticizers, foam nucleating agents, crystallization nucleating agents, superficial modifiers and anti-static agents, or other types of additives.

As mentioned above, embodiments of the present disclosure encompass shrink films that have at least one layer formed from the aforementioned blended ethylene-based polymer composition. As disclosed herein, shrink films may comprise one layer, (i.e., may be a monolayer film) or may comprise two or more layers (i.e., may be a multilayer film), wherein at least one of the layers comprises the blended ethylene-based polymer composition described above.

In particular embodiments, each layer of the shrink film is formed from the blended ethylene-based polymer composition. Other embodiments may use one or two layers formed only from virgin resin (HDPE and/or LDPE and/or LLDPE, which may optionally be biobased) in combination with the blended composition in at least one of the other layers, while other embodiments may use one or two layers formed from PCR in combination with the blended composition in at least one of the other layers. For example, virgin resins (optionally biobased) may form the inner and outer layer while the middle layer is formed from the blended polymer composition. However, it is intended that any combination of layers may be formed in accordance with the present disclosure, for example, where the blended composition is present in a layer other than the middle layer.

Further, as discussed above, in one or more embodiments, virgin resin present in the shrink film may be biobased HDPE, LDPE, and/or LLDPE. Such biobased resins may be present in any one of the layers (or all of the layers) either with 100% virgin content or in a blended composition (i.e., there being no virgin petrochemical resin being present). In a particular construction, the inner and outer layer may be formed from virgin biobased HDPE, LDPE, and/or LLDPE, while the middle layer is formed from the blended composition (which itself is a blend of PCR with a virgin biobased resin).

The ethylene-based polymer composition may be formed by blending (such as by dry blending or melt blending) PCR with a virgin resin (HDPE and/or LDPE and/or LLDPE, which may all be biobased), and in particular embodiments, the amounts selected for blending may be selected based on consideration of reduction of CO₂ emissions, as described above to have an Emission Factor less than or equal to 1.0 kg CO₂/kg of the ethylene-based polymer composition. The ethylene-based polymer composition may thusly be co-extruded, depending on the final selection of the composition of each of the layers, to form a multilayer film.

For example, films may be produced by coextrusion, coating preparation, lamination, and extrusion, including blown film extrusion or cast film extrusion. The film may be uniaxially or biaxially oriented. Uniaxially oriented film may be oriented in the longitudinal or transverse direction. Several embodiments of the present disclosure may be extruded or coextruded film in one step or two steps by stretching or drawing step longitudinal stretching orientation.

### EXAMPLES

In the following examples, three structures of shrink films were prepared in order to assay for the properties as disclosed herein. Table 1 presents the materials used for the formulations in each layer and the correspondent properties of each resin.

[symbol]

TABLE 1
Materials used in film preparation

| | | Test | | |
|---|---|---|---|---|
| Material | Property | Method | Value | Unity |
| LDPE | Melt index (190° C./2.16 kg) | D 1238 | 0.27 | g/10 min |
| TX7003 | Density | D 792 | 0.922 | g/cm³ |
| available | Tensile strength at break (MD/TD)¹ | D 882 | 20/20 | MPa |
| by | Elongation at break (MD/TD)¹ | D 882 | 380/910 | % |
| Braskem | Tensile modulus at 2% secant (MD/TD)¹ | D 882 | 140/150 | MPa |
| | Dart drop impact¹ | D 1709 | 230 | g/F50 |
| | | (A) | | |
| | Elmendorf tear strength (DM/DT)¹ | D 1922 | 300/220 | gF |
| | Haze¹ | D 1003 | 20 | % |
| | Gloss at an angle of 45°¹ | D 2457 | 39 | — |
| HDPE | Melt Index (190° C./2.16 kg) | D 1238 | 0.3 | g/10 min |
| HD7600U | Density | D 792 | 0.954 | g/cm³ |
| available | Tensile strength at yield^{2,a} | D 638 | 30 | MPa |
| by | Tensile strength at break^{2,a} | D 638 | 33 | MPa |
| Braskem | Flexural modulus at 1% secant^{2,b} | D 790 | 1136 | MPa |
| | Shore D Hardness^{2,c} | D 2240 | 64 | Shore D |
| | Environmental Stress Cracking resistance 10% | D 1693 | 100 | h/F50 |
| | IGEPAL^{2,a} | (B) | | |
| | Environmental Stress Cracking resistance 100% | D 1693 | 200 | h/F50 |
| | IGEPAL^{2,a} | (C) | | |
| | Deflection Temperature under Load at 0.455 MPa^{2,b} | D 648 | 66 | ° C. |
| | Vicat Softening Temperature at 10 N^{2,b} | D 1525² | 128 | ° C. |
| PCR | Melt Index (190° C./2.16 kg) | D 1238 | 0.54 | g/10 min |
| (LLDPE- | Density | D 792 | 0.928 | g/cm³ |
| PCR | Tensile strength at break (MD/TD)³ | D 882 | 24/23 | MPa |
| obtained | Tensile strength at yield (MD/TD)³ | D 882 | 9/11 | MPa |
| from | Tensile modulus at 1% secant (MD/TD)³ | D 882 | 199/234 | MPa |
| industrial | Dart drop impact³ | D 1709 | 165 | g/F50 |
| bags | | (A) | | |
| recycling) | Elmendorf tear strength (DM/DT)³ | D 1922 | 120/646 | gF |

¹Film of 70 μm thickness, obtained in a 50 mm extruder, with a blow ratio of 2.3: 1, a die opening of 1.0 mm
²Test specimens from compression molded plaque according to ASTM D4703. Plaque Thickness: a) 2 mm b)3 mm c) 6 mm
³Film of 60 μm thickness, obtained in a 30 mm extruder, with a blow ratio of 2.2: 1, a die opening of 1.8 mm

Three different 3-layers shrink film structures were produced varying the quantity of PCR in each formulation. Films were produced on a Carnevalli PO 1800 3-layer Coextruder. The machine features two 60 mm extruders at the ends and a 75 mm extruder at the core layer. The following processing conditions have been set: (i) Productivity: 180 kg/h; (ii) Blow Ratio: 2.6:1 (film width 1430 mm); (iii) Mist line height: 800 mm; (iv) film thickness: 50 μm.

Table 2 summarizes the film structures produced.

TABLE 2
Shrink film formulations

| | | Total | | | | | | |
|---|---|---|---|---|---|---|---|---|
| | | thickness | | | | | | |
| | | of the | | | | Slip | | |
| | | Film (%) | LDPE | HDPE | PCR | Agent | Antioxidant | Colorant |
| Film 1 | | | | | | | | |
| 13 wt % | Layer 1 | 25% | 83.3 wt % | 15.0 wt % | — | 1.7 wt % | — | — |
| PCR | Layer 2 | 50% | 19.0 wt % | 50.0 wt % | 26.0 wt % | — | 1.0 wt % | 4.0 wt % |
| | Layer 3 | 25% | 79.2 wt % | 15.0 wt % | — | 1.8 wt % | — | 4.0 wt % |
| Total wt % of the film | | | 50.1 wt % | 32.5 wt % | 13.0% | 0.9 wt % | 0.5 wt % | 3.0 wt % |
| Film 2 | | | | | | | | |
| 22.5 wt % | Layer 1 | 25% | 98.0 wt % | — | — | 2.0 wt % | — | — |
| PCR | Layer 2 | 50% | — | 50.0 wt % | 45.0 wt % | — | 1.0 wt % | 4.0 wt % |
| | Layer 3 | 25% | 93.6 wt % | — | — | 2.4 wt % | — | 4.0 wt % |
| Total wt % of the film | | | 47.9 wt % | 25.0 wt % | 22.5 wt % | 1.1 wt % | 0.5 wt % | 3.0 wt % |
| Film 3 | | | | | | | | |
| 37.5 wt % | Layer 1 | 25% | 98.0 wt % | — | — | 2.0 wt % | — | — |
| PCR | Layer 2 | 50% | — | 20.0 wt % | 75.0 wt % | — | 1.0 wt % | 4.0 wt % |
| | Layer 3 | 25% | 93.6 wt % | — | — | 2.4 wt % | — | 4.0 wt % |

| | | | | | | |
|---|---|---|---|---|---|---|
| Total wt % of the film | 47.9 wt % | 10.0 wt % | 37.5 wt % | 1.1 wt % | 0.5 wt % | 3.0 wt % |

Table 3 summarizes the properties obtained for each Shrink film produced in accordance to the present disclosure.

TABLE 3
Properties of the shrink film structures

| | Test | Value | | | |
|---|---|---|---|---|---|
| Property | Method | Film 1 | Film 2 | Film 3 | Unity |
| Gloss at an angle of | D 2457 | 20 | 18.3 | 23.6 | — |
| 45° | | | | | |
| Elmendorf tear | D 1922 | 44/1281 | 45/1065 | 50/670 | gF |
| strength (DM/DT) | | | | | |
| Shrink strength | D2732 | 80/15 | 78/16 | 78/18 | % |
| (DM/DT) | | | | | |
| Cold seal at | F2029 | 34 | 32.6 | 28.8 | N |
| medium strength | | | | | |
| Cold seal at | F2029 | 41.3 | 39.6 | 36.8 | N |
| maximum strength | | | | | |
| Cold seal sealing | F2029 | 120 | 115 | 115 | ° C. |
| temperature | | | | | |
| tensile modulus at | D882 | 392/490 | 265/433 | 303/362 | MPa |
| 1% secant | | | | | |
| (MD/TD) | | | | | |
| tensile strength at | D882 | 12.4/16.6 | 11.4/15.3 | 10.4/13.4 | MPa |
| yield (MD/TD) | | | | | |
| Tensile strength at | D882 | 25.4/21.7 | 23.5/19.6 | 24.3/20.5 | MPa |
| break (MD/TD) | | | | | |

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

1. A shrink film, comprising:
at least one layer comprising a blended ethylene-based polymer composition, the blended ethylene-based having a PCR content varying from greater than 5 to less than 95wt % and a virgin resin content varying from greater than 5 to less than 95wt %, wherein the virgin resin is selected from HDPE, LLDPE, LDPE, or combinations thereof.

2. The shrink film of claim 1, wherein the blended ethylene-based polymer composition comprises PCR blended with a virgin LDPE and optionally a virgin HDPE and/or LLDPE.

3. The shrink film of claim 1, wherein the film includes at least a first layer, a second layer, and a third layer, wherein the blended ethylene-based polymer composition is in the second layer.

4. The shrink film of claim 3, wherein the first layer and the third layer include a virgin resin selected from HDPE, LDPE, LLDPE, and blends thereof.

5. The shrink film of claim 1, wherein the film has a PCR content ranging from 5 to 70 wt % based in the total weight of the film, a LDPE content of at least 25 wt % based in the total weight of the film; optionally a virgin LLDPE content of less than 50 wt % based in the total weight of the film and optionally a HDPE content of less than 40 wt % based in the total weight of the film.

6. (canceled)

7. The shrink film of claim 1, wherein the blended ethylene-based polymer composition comprises a virgin biobased HDPE and/or a virgin biobased LDPE and/or a virgin biobased LLDPE, and wherein the blended ethylene-based polymer compositions exhibits a biobased carbon content as determined by ASTM D6866-18 Method B of at least 5%.

8. The shrink film of claim 7, wherein the wt % of each component in the blended ethylene-based polymer composition is selected such that the blended ethylene-based polymer composition exhibits an Emission Factor_{Blend} in the range of −1.0 to 1.0 kg CO2l kg of the blended ethylene-based polymer composition, as determined according to the formula:
P1_{Biobased}·Emission factor_{P1Biobased}+P2_{Recycled}·Emission factor_{P2Recycled}+P3_{Petro}·Emission factor_{P3Petro}=Emission factor_{blend};
wherein P1_{Biobased} is the weight percentage of the biobased HDPE, biobased LDPE, or biobased LLDPE, P2_{Recycled} is the weight percent of the PCR, and P3_{Petro} is the weight percent of the virgin petrochemical based HDPE, petrochemical based LDPE or petrochemical based LLDPE; Emission factor_{P1Biobased} is the calculated emission for the biobased HDPE, biobased LDPE, or biobased LLDPE in kg CO₂/kg PE, Emission factor_{P2Recycled} is the calculated emission for the PCR in kg CO₂/kg PE, Emission factor_{P3Petro} is the calculated emission for the the virgin petrochemical based HDPE, petrochemical based LDPE or petrochemical based LLDPE, and Emission factor_{Blend} is the calculated emission for the blended ethylene-based polymer composition in kg CO₂/kg blended ethylene-based polymer composition.

9. (canceled)

10. (canceled)

11. The shrink film of claim 1, wherein the HDPE and/or LDPE and/or LLDPE in the blended ethylene-based polymer compositions has a melt index measured according to ASTM D1238 at 190° C./2.16 kg ranging from 0.1 to 2 g/10 min.

12. The shrink film of claim 1, wherein the HDPE in the blended ethylene-based polymer composition has a density measured according to ASTM D 792 ranging from 0.940 to 0.960 g/cm³, and the LDPE and/or LLDPE in the blended ethylene-based polymer composition has a density measured according to ASTM D 792 ranging from 0.910 to 0.930 g/cm³.

13. (canceled)

14. The shrink film of claim 1, wherein the HDPE in the blended ethylene-based polymer composition has at least one of:
a flexural modulus at 1% secant, measured according to ASTM D 790 greater than 900 MPa;
an environmental stress cracking resistance, measured according to ASTM D 1693 Condition B, that is greater than 5 hours to 50% failure;
a Shore D hardness, measured according to ASTM D 2240, greater than 50 Shore D;
a heat deflection temperature, measured according to ASTM D648 under load at 0.455 MPa, greater than 50° C.;
a Vicat softening temperature at 10N, measured according to ASTM D1525, greater than 90° C.; or
combinations thereof.

15. (canceled)

16. (canceled)

17. (canceled)

18. (canceled)

19. (canceled)

20. The shrink film of claim 1, wherein the LDPE in the blended composition has at least one of:
a tensile strength at break, measured according to ASTM D 882 in machine direction (MD) greater than 10 MPa and in transversal direction (TD) greater than 10 MPa;
an elongation at break, measured according to ASTM D 882 in machine direction (MD) greater than 250% and in transversal direction (TD) greater than 700%;
a tensile modulus at 2% secant, measured according to ASTM D 882 in a machine direction (MD) greater than 90 MPa and in transversal direction (TD) greater than 100 MPa;
a Dart Drop impact, measured according to ASTM D1709, Method A, of greater than 100 g (F50);
an Elmendorf tear strength, measured according to ASTM D 1922, that is greater than 150 gF in machine direction (MD) and greater than 120 gF in transversal direction (TD);
a haze, measured according to ASTM D 1003, of lower than 60%;
a gloss at a 45° angle, measured according to ASTM D2457 of greater than 15; or combinations thereof.

21. (canceled)

22. (canceled)

23. (canceled)

24. (canceled)

25. (canceled)

26. (canceled)

27. (canceled)

28. The shrink film of claim 1, wherein the PCR in the blended ethylene-based polymer composition has at least one of:
a melt index measured according to ASTM D1238 at 190° C./2.16 kg ranging from 0.1 to 3 g/10 min;
a density measured according to ASTM D 792 ranging from 0.900 to 0.960 g/cm³;
a tensile strength at yield, measured according to ASTM D 882, that is greater than 3 MPa at machine direction (MD) and greater than 6 MPa at transversal direction (TD);
a tensile strength at break, measured according to ASTM D 882, that is greater than 10 MPa at machine direction (MD) and greater than 10 MPa at transversal direction (TD);
tensile modulus at 1% secant, measured according to ASTM D 882, of greater than 90 MPa at machine direction (MD) and greater than 100 at transversal direction (TD);
a Dart Drop impact, measured according to ASTM D1709 Method A, of greater than 100 g (F50);
an Elmendorf tear strength, measured according to ASTM D 1922, that is greater than 75 gF at machine direction (MD) and greater than 300 gF at transversal direction (TD); or
combinations thereof.

29. (canceled)

30. The shrink film of claim 1, wherein the PCR is a LLDPE PCR.

31. The shrink film of claim 1, wherein the PCR is derived from industrial bags.

32. (canceled)

33. (canceled)

34. (canceled)

35. (canceled)

36. (canceled)

37. The shrink film of claim 1, wherein the film has a gloss at an angle of 45°, measured according to ASTM D2457 that is greater than 10.

38. The shrink film of claim 1, wherein the film has an Elmendorf tear strength, measured according to ASTM D 1922, that is greater than 20 gF in machine direction (MD) and greater than 600 gF in transversal direction (TD).

39. The shrink film of claim 1, wherein the film that has shrink strength, measured according to ASTM D2732, that is greater than 50% at machine direction and greater than 8% at transversal direction.

40. The shrink film of claim 1, wherein the film has a cold seal at medium strength, measured according to ASTM F2019, of greater than 20 N.

41. The shrink film of claim 1, wherein the film has a cold seal at maximum strength, measured according to ASTM F2019, greater than 25 N.

42. The shrink film of claim 1, wherein the film has a cold seal sealing temperature, measured according to ASTM F2019, of less than 130° C.

43. The shrink film of claim 1, wherein the film has a tensile modulus at 1% secant, measured according to ASTM D 882, of greater than 150 MPa in machine direction (MD) and greater than 250 MPa in transversal direction (TD).

44. The shrink film of claim 1, wherein the film has a tensile strength at yield, measured according to ASTM D 882, of greater than 8 MPa in machine direction and greater than 10 MPa in transversal direction.

45. The shrink film of claim 1, wherein film has a tensile strength at break, measured according to ASTM D 882, of greater than 15 MPa in machine direction (MD) and greater than 12 MPa in transversal direction (TD).

46. A method for preparing the shrink film of claim 1, the method comprising:
dry blending or melt blending the PCR and the virgin resin selected from HDPE, LDPE, LLDPE, or combinations thereof to form the blended ethylene-based polymer composition; and
extruding the shrink film of claim 1.

47. (canceled)

48. The method of claim 46, wherein extruding comprises forming film in blown film extrusion or cast film extrusion.

49. (canceled)
